(19) United States
(12) Patent Application Publication
(10) Pub. No.: US 2012/0039579 A1
(43) Pub. Date: Feb. 16, 2012

(54) MULTI-ANGLE AUDIO AND VIDEO PRODUCTION SYSTEM AND METHOD

(75) Inventor: Peter Esposito, Brooklyn, NY (US)

(73) Assignee: PLAY PUSHER, INC., Brooklyn, NY (US)

(21) Appl. No.: 13/209,118

(22) Filed: Aug. 12, 2011

Related U.S. Application Data
(60) Provisional application No. 61/372,907, filed on Aug. 12, 2010.

(51) Int. Cl. H04N 5/77

(52) U.S. Cl. 386/224; 386/E05.069

(57) ABSTRACT

An easy to use self-contained mobile multi-angle audio and video production systems for recording audio and video of an event from multiple different view points in real time, tagging the recorded content and making the media available for viewing and sale, either during or shortly after the event.

### CROSS REFERENCE TO RELATED APPLICATIONS

The present application claims the benefit of U.S. Provisional Application Ser. No. 61/372,907 filed 12 Aug. 2010 which is incorporated herein by reference in its entirety.

### FIELD

In general, the disclosure relates to an audio and video recording system. More particularly, the disclosure relates to a video production system capable of recording audio and video in real time and producing a plurality of recorded media with tagged content.

### BACKGROUND

Audio and/or video recording devices are well known and used by many to record sporting events, performances, and many other events. Typically, recording of such events is conducted by an amateur videographer, a parent or relative, a coach, or other person (with a relatively low budget and less-than-professional skills). Recording of an event by the videographer, parent, or coach may be inconsistent because the quality of the recording depends on the individual person operating the audio/video source. Typically, the individual making the recording can only record from one view point or angle. There may be obstructions in front of the person recording the event, such as fences, other individuals, or other objects. Thus, the quality of the recording may be reduced due to the presence of obstructions.

Additionally, the videographer, parent, or coach recording the event may have to place himself/herself near the court, field, stage, etc. to obtain a quality recording of the event. Placing himself/herself near the court or field may be dangerous. For example in baseball, the person recording the event may run the risk of being struck by a ball. Further, the individual recording the event may not be able to view the event fully because the individual must concentrate on recording the event throughout the duration of the event.

Typically, if one wanted to produce a quality recorded video of an event that could be sold, he/she would have to combine multiple recordings from multiple recording devices. The combining process can take a significant amount of time, even days, due to the process of editing the multiple recordings into one recorded media. The editing process requires the multiple audio/video recordings to be parsed into sections. Then the sections must be recombined at the correct intervals to avoid any distortion or loss of the audio or video content, such that the audio/video from the multiple recording devices form a continuous high quality recording of the event.

Additionally, to get a quality recording from multiple angles, a logistical issue arises from having to carry separate pieces of equipment to different locations and then connect cabling for the entire set-up. This is often very difficult for one person to handle moving and setting up all the equipment involved, including multiple cameras, recorders, media, cabling, etc.

Further, it is often desirable to associate text and data files to the recorded video images and video clips or to combine or merge various images and clips. This typically takes additional time during the editing process and results in delay between the time the video is recorded and the time it is available.

### SUMMARY

The present invention provides a self-contained, mobile, multi-angle audio and video production system, and methods of making, using, and operating the multi-angle audio and video production system. The present embodiment of the self-contained mobile multi-angle audio and video production system combines the audio and video recording and editing equipment and cameras for multiple views into a self-contained enclosure that includes all the equipment needed to generate recorded media and multiple DVD production. More specifically, embodiments relate to an easy to use mobile multi-angle audio and video production system capable of carrying all equipment and recording audio and video of an event from multiple different view points in real time and producing a plurality of recorded media available for use and sale either during, contemporaneously with, or shortly after the event, such as within minutes after the event.

An embodiment of the mobile multi-angle audio and video production system includes a carrying case, at least one mounting stand having at least one mounting platform, at least one audio and/or video source, a switcher, RCA audio/video cables, and an audio and/or video recorder. The carrying case may have a handle or strap attached to a top of the carrying case, and have wheels attached to a bottom of the carrying case allowing the carrying case to be easily transported. Additionally, or alternatively, the carrying case may have a strap system for carrying in a backpack or over the shoulder fashion. The carrying case may have a plurality of storage compartments to house all of the components of the mobile multi-angle audio and video production system.

The carrying case, containing all of the components, may be transported to an event. The carrying case may be opened and the mounting stand attached to a portion, such as a side, of the carrying case allowing the mounting stand to extend either vertically or horizontally from the carrying case. The mounting stand has at least one mounting platform rotatably attached to the mounting stand to allow for the mounting platform to rotate 360 degrees about an axis of the mounting stand and/or 360 degrees about an axis perpendicular to the axis of the mounting stand to adjust orientation and tilt angle, respectively, of the camera.

The RCA cables may be attached to the at least one audio/video source, such as a camera, and to the switcher. If using more than one audio/video source, each of the audio/video sources may be attached to the switcher. The switcher may have buttons on a top of the switcher corresponding to each audio/video source. Thus, the switcher receives the audio/video from the audio/video source(s). The audio/video source(s) may be mounted onto the mounting platform(s) and rotated or positioned to obtain the desired view(s) of the event. The switcher may be connected to the audio/video recorder. Thus, the audio/video recorder receives the selected audio/video from the switcher.

An operator may load the audio/video recorder with a recordable media. Once all of the components are connected to a power source, which may or may not be embedded within the system, the operator may record the event. The operator may record the event from different views corresponding to the position of the audio/video sources, by placing the audio video recorder on record. To change from one view in real time the operator may simply press the button on the switcher corresponding to the audio video source the operator desires to record from. The changes in audio/video sources may be done in real time allowing the operator to record a single event from multiple views onto a recordable media. Additionally, the operator may capture and delay the feed from one or more video sources before switching to record that media, thus providing the capability to record multiple angles of the same scene consecutively without the normal requirement of editing software to combine multiple video sources that captured the same moment.

Advantages of the embodiments of the invention are to provide a self-contained and easy to transport, easy to set up, easy to use, portable system that allows an operator to record an event in real time from multiple viewing angles and create multiple recorded media of the event either during or within minutes after the event, with or without being tethered to a fixed wall power source at the location. Further, the system allows for the placement of the audio/video sources anywhere around an event to obtain a clear view of the event without having to continuously move or position the audio/video source(s).

Further embodiments enable a user to record videos and photos, and seamlessly and quickly “tag” that media with relevant information, such as “scoring the play” for statistics, or adding text notes about the play or player. The device may include “paired-clip recording technology” designed to replace the pen and paper method of “doing the book” on a player or a game. The device enables a three-step digital scroll menu that allows the user to select text titles at each step of the process.

In an embodiment, first the user records the video content. Second, the user selects the player's ID number, such as a uniform number, third, the user selects the play outcome from the predefined menus. Finally, the system internally translates the inputted data into the appropriate “book code”. If the user does not enter the play outcome in step three, the system still processes step two thus tagging the individuals involved in that clip.

In an embodiment, there is a mobile video production system comprising at least one camera for capturing the digital media data, a recording device for storing the digital media data, a tagging device for tagging the digital media data with related information data, and a processor for associating the digital media data with the related information data.

In another embodiment, the system comprises a second camera for capturing a second digital media data or video. In this embodiment, the second digital media data has a different attribute than the digital media data, such as a different focal length, a different focal position, or a different image speed (frames per second).

In another embodiment, the system comprises a controller for the operator that allows the operator to control the cameras, the data input, and the data capture. In still another embodiment, the system further comprises a multifunction display. The multifunction display is capable of displaying at least a slow motion video stream, a still photo, a video image, a split screen image, a menu, and a data screen.

In another embodiment, the system further comprises a platform, where all of the equipment, including the camera, the recording device, the tagging device, and the processor are mounted. In one embodiment, the controller is integrated into the platform.

Another embodiment comprises a method for capturing and tagging event video, capturing a first video image via a first camera, capturing a second video image via a second camera where the first video image and the second video image are captured simultaneously. This allows for recording the first video image in a digital format and the second video image in a digital format, and associating the first video image with the second video image, for example, using a tag. This also allows for tagging the associated first video image and the second video image with a data file, and storing the first video image, the second video image, and the data file, as separate files. In another embodiment, the second video image may be one or more still images.

In one embodiment, the data files are selected from a list of predefined identifiers. In another embodiment, the system provides alerts to the operator to simplify the recording, capturing, and tagging process.

In another embodiment, the equipment is mounted to a tripod. In a further embodiment, the platform comprises an alignment device that allows for the adjustment of the two cameras. In one embodiment, the alignment device allows for manual adjustment of each camera and in another embodiment, the alignment device allows for the automatic adjustment of the two cameras. The platform may also contain controls for automatically and/or simultaneously adjusting the two cameras or each camera independently.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a perspective view of an interior of an embodiment of a multi-angle audio and video production system in a closed position;

FIG. 2 illustrates a perspective view of the interior of an embodiment of the multi-angle audio and video production system in an open position;

FIG. 3 is a schematic representation of a device in an embodiment of the present system;

FIG. 4 is a schematic representation of a device in an embodiment of the present system;

FIGS. 5(a)-(b) are schematic representations of a top view and front view of a controller, respectively, in an embodiment of the present system;

FIGS. 6(a)-(b) are representations of display screens in an embodiment of the present system;

FIG. 7 depicts a representation of a device in an embodiment of the present system;

FIG. 8 depicts a representation of a device in an embodiment of the present system; and

FIG. 9 depicts a representation of a mounting device to be used in accordance with an embodiment of the present system.

### DETAILED DESCRIPTION

In general, embodiments of the invention relate to self-contained portable, multi-angle audio and video production systems, and methods of making, using, and operating the multi-angle audio and video production systems according to the invention.

Detailed embodiments of the present invention are disclosed herein; however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention.

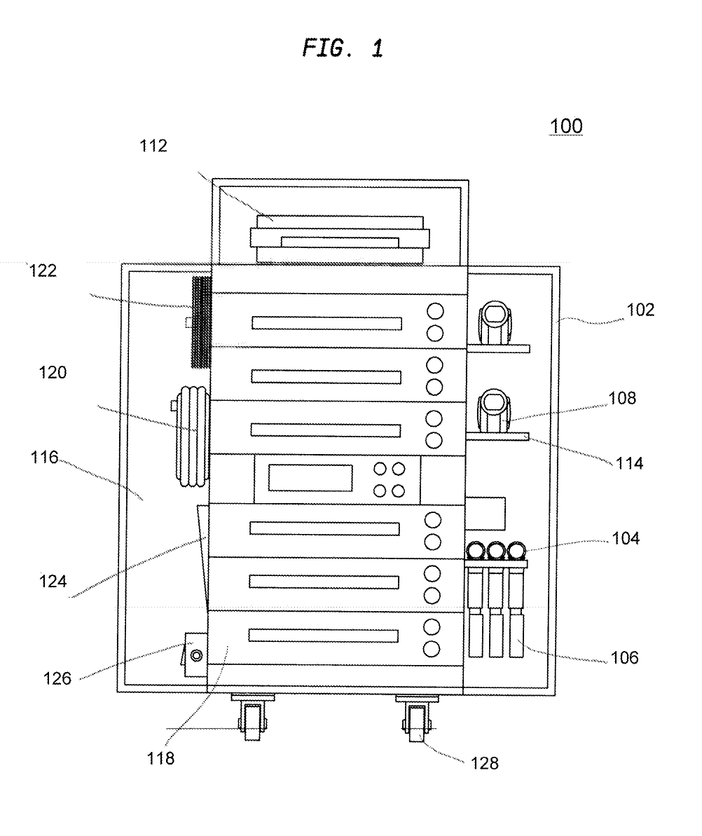

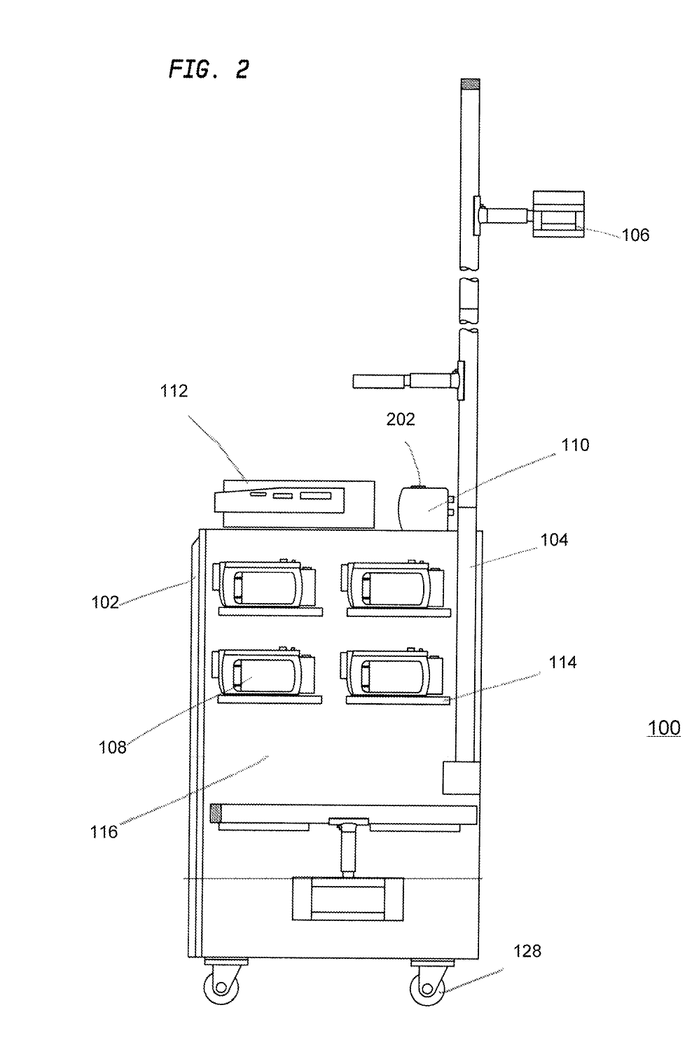

A multi-angle audio and video production system according to an illustrative embodiment of the invention is described with reference to the perspective view shown in FIGS. 1 and 2. The multi-angle audio and video production system 100 includes a carrying case 102, at least one mounting stand 104 having at least one mounting platform 106, at least one audio and/or video source 108, a switcher 110, and an audio and/or video recorder 112.

The carrying case 102 may be made of any suitable material, such as but not limited to metals, polymers, plastics, woods, rubbers, or any other material desired. Preferably, the case 102 is weather proof, and made of lightweight, durable material. The carrying case 102 may have at least one storage compartment 114 in an interior 116 of the carrying case to house each separate component or part of the mobile multi-angle audio and video production system for easy transport of the system. For example, the carrying case may be capable of housing the mounting stand 104 having at least one mounting platform 106, the at least one audio/video source 108, the switcher 110, the audio/video recorder, 112, a duplicator 118, RCA cables, S video cables 120, blank recordable media 122, sales material (order forms, envelopes, and money) in a handy folder 124, and a power strip 126. The carrying case 102 may also have storage compartments 114 in a front interior and a back interior of the carrying case 102. The storage compartments 114 may be padded to prevent damage or movement of the components within carrying case 102 during the transportation of the carrying case 102.

The carrying case 102 may be openable and closeable for easy access to the components and for protection of the components during transport of the system. The openable and closeable function of the carrying case 102 may be accomplished by an openable lid attached to a top of the carrying case 102, or an openable door attached to one or more sides of the carrying case 102. Alternatively, the carrying case 102 may be of a suitcase type design wherein the carrying case 102 includes two hinged, jointed case shells. The carrying case 102 may further include a lock. When closed the carrying case 102 may be locked to prevent the carrying case 102 from opening accidentally and to provide security for the components of the system.

The carrying case 102 may include at least one wheel 128 attached to a bottom of carrying case 102 to facilitate easy transport of the carrying case 102. The carrying case 102 may include a handle or strap attached to a side or a back of the carrying case 102. The handle or strap may be a retractable handle or strap that retracts into the carrying case 102 when not in use and can be extended from the carrying case 102 when in use. Additionally, or alternatively, carrying case 102 may have a strap system (not shown) for carrying the case in a backpack or over the shoulder fashion.

The at least one mounting stand 104 may be attached to and detached from a portion, such as the exterior, of the carrying case 102. The mounting stand 104 may, alternatively or in addition, be attached to a side, a front, a back, a top, or a bottom of the carrying case 102. When attached the mounting stand 104 may extend vertically or horizontally from the carrying case 102. As illustrated in FIGS. 1 and 2, the mounting stand 104 extends vertically approximately 3 feet from the carrying case 102. However, it is appreciated that the mounting stand 104 may extent a shorter distance, 0-2 feet for example, or a larger distance, 3-10 feet from the carrying case 102.

The mounting stand 104 may be made up of one solid piece or multiple portions that attach to and detach from one another. As illustrated in FIGS. 1 and 2, the mounting stand 104 is made up of 3 portions of substantially equal size that attach to and detach from one another to allow for the mounting stand 104 to be disassembled and placed within the carrying case for easy transport. Alternatively, the 3 portions of the mounting stand 104 may be placed separately around an event to obtain different view points. Although the mounting stand 104 is shown in FIGS. 1 and 2 as having 3 portions, it is appreciated that the mounting stand 104 may have fewer portions (1-2, for example) or more portions (4-10, for example). The multiple portions of the mounting stand 104 may be attached and detached from one another in any manner such as, but not limited to threads, pins, locking pins, screws, bolts, flanges, or any other attachment mechanism of the type. Alternatively, the mounting stand 104 may be extendable telescopically.

The mounting stand 104 may have at least one mounting platform 106 attached to the mounting stand 104. Further, the mounting stand 104 may have at least one mounting platform 106 attached to each portion of the multiple portion mounting stand 104. As shown in FIGS. 1 and 2, the mounting stand 104 has 3 mounting platforms 106, one attached to each of the 3 portions of the mounting stand 104. However, it should be appreciated that there may be fewer mounting platforms (1-2, for example) or more mounting platforms (4-10, for example) attached to the mounting stand 104. The at least one mounting platform 106 may be rotatably attached to the mounting stand 104 to allow for the mounting platform 106 to rotate 360 degrees about an axis of the mounting stand 104 to adjust the tilt angle of the mounting platform 106 and camera. Further, the mounting platform 106 may also be rotatably attached to the mounting stand 104 to allow for the mounting platform 106 to rotate 360 degrees about an axis perpendicular to the axis of the mounting stand 104.

The mounting stand 104 and mounting platform(s) 106 may have detents, numbered notches, or numbered positions corresponding to a selected angular range. The detents, numbered notches, or numbered positions may also correspond to the position of the mounting platform(s) 106 relative to the position of the mounting stand 104. The detents or numbered positions may allow an operator to select a specific angular range of view from a specific mounting platform 106 on the mounting stand 104.

The at least one audio/video source 108, e.g. a camera, may be mounted onto the at least one mounting platform 106. As shown in FIGS. 1 and 2, there are 4 audio/video sources 108; however, it is appreciated that there may be fewer audio/video sources (1-3, for example) or more audio/video sources (5-10, for example). The audio/video sources 108 may be mounted onto each of the separate mounting platforms 106 via any of various methods, such as but not limited to straps, threads, screws, bolts, and other means of the type.

The at least one audio/video source 108 may be any camera capable of transmitting video and/or audio, such as but not limited to a JVC Everio Camcorder, a Sony Handycam, Canon zr-200's cameras, and any other camera of the type. The audio/video source(s) 108 may have coded output ports, for example an RCA output port and/or an S video output port, to transmit the video and/or audio from the audio/video source(s) 108 to the switcher 110. Additionally, the audio/video source(s) 108 may be capable of wireless transmission of audio and/or video output to a switcher 110 capable of wireless reception of the audio and/or video output transmission from the audio/video source(s) 108.

The switcher 110, which in this illustrative embodiments is a RCA Video Source Selector, Model No. VH911, may include at least one coded input port, for example an RCA input port and/or an S video input port, to receive the video and/or audio from the audio/video source(s) 108, and at least one coded output port, for example an RCA output port and/or an S video output port, to transmit audio and/or video to the audio/video recorder 112. RCA cables and/or S video cables may be connected to the RCA and/or S video output ports of the audio/video source(s) 108 and to the RCA and/or S video input ports of the switcher 110. Further, RCA cables and/or S video cables may be connected to the RCA and/or S video output ports of the switcher 110 and to the RCA and/or S video input ports of the audio/video recorder 112. The switcher 110 may have at least one control button 202 to select the audio and/or video feed from the audio/video source 108 to transmit to the audio/video recorder 112. The illustrative switcher 110 includes four control buttons 202 corresponding to four sets of audio and/or video input ports. However, it is appreciated that the switcher 110 may include a fewer number or a greater number of audio and/or video input ports and buttons 202, such as for example 1-3, 1-6, and 1-10.

The switcher 110 may include additional control buttons, such as programmable control buttons, to allow the operator to control the start and stop operation of the audio/video recorder 112, such as a record button, a pause button, a stop button, a rewind button, a fast forward button, and other buttons to provide additional hand-held functionality that could be programmed into the switcher.

Further the switcher 110 may be programmable to receive and transmit audio and/or video input and output wirelessly. The switcher 110 may be programmable to receive wireless transmission of audio and/or video output from the audio/video source(s) 108. The switcher may be programmable to transmit wireless transmission of audio and/or video input to the audio/video recorder 112, wherein the audio/video recorder 112 is capable of receiving wireless transmission of audio and/or video input from the switcher 110.

Additionally, the switcher 110 may be modified and programmable to receive multiple coded input sources and combine them into a single coded output source. For example, to create a single output source from multiple input sources and produce an output source in a split screen manner, wherein the split screen can be capable of displaying two input sources simultaneously.

The audio/video recorder 112 may include at least one coded input port, for example an RCA input port and/or S video input port, to receive the video and/or audio from the switcher 110. The audio/video recorder 112 may be capable of receiving wireless transmission of audio and/or video input from the switcher 110. The audio/video recorder 112 may be any of various recording devices capable of receiving and producing a recorded media, such as but not limited to commercial DVD and/or CD burners, for example a Sony Direct Burn VRD-MC5, MC6, or MC10, and other recording devices of the type. The recorded media may be any type or recorded media, such as but not limited to Compact Discs (CDs), Digital Versatile Discs (DVDs), Secure Digital (SD), CompactFlash (CF), SmartMedia (SM), Memory Stick (MS), MultiMediaCard (MMC), xD-Picture Card (xD), Universal Serial Bus (USB) and other recordable media of the type. The audio/video recorder 112 may include a memory card slot and be programmable to accept an image, such as a JPEG image, from which a main menu may be created on the recorded media. The audio/video recorder 112 may be capable of receiving and producing a plurality of recorded media simultaneously. Alternatively, a duplicator 118 may be employed to receive and produce a plurality of recorded media simultaneously, such as 10-100 recorded media at high speeds. The duplicator 118 may be any of various duplicators capable of receiving and producing a plurality of recorded media simultaneously, such as but not limited to commercial DVD and/or CD duplicators, for example a Megalynx 1-11 duplicator, and other duplicators of the type.

The multi-angle audio and video production system 100 may also include a power strip and/or surge protector. The power strip and/or surge protector 126 may be mounted on the interior of the carrying case 102. The power strip and/or surge protector 126 may allow for all of the electronic components of the multi-angle audio and video production system 100, such as the audio/video source(s) 108, the switcher 110, the audio/video recorder 112, and the duplicator to plug into the power strip and/or surge protector. Thus, the power strip and/or surge protector allows for a single cord to be connected to a power source to supply power to all of the electronic components of the multi-angle audio and video production system 100. The power source for the multi-angle audio and video production system 100 may include an electrical outlet found at the site of the event or a portable generator that may or may not be enclosed within the system.

Other aspects of the invention relate to methods of setting up and using the multi-angle audio and video production system. To set up the multi-angle audio and video production system 100, an operator transports the system 100 to a position at an event where the operator will record video from. The operator then opens the carrying case 102. The operator assembles the portions of the mounting stand 104 and ensures it is attached the carrying case 102. The operator removes the audio/video source(s) 108 and attaches the RCA or S video cables to the output ports of the audio/video source(s) 108. The operator attaches the opposite end of the RCA or S video cables, that are attached to the output ports of the audio/video source(s) 108, to the corresponding input ports of the switcher 110. The operator attaches another RCA or S video cable to the output port(s) of the switcher 110. The operator attaches the opposite end of the RCA or S video cable, that are attached to the output port(s) of the switcher 110, to the input port(s) of the audio/video recorder 112. The operator mounts the audio/video source(s) 108 to the mounting platform(s) 106. The operator then positions the audio/video source(s) 108 to capture the desired angular view or position the operator desires.

Alternatively, the operator may not assemble the portions of the mounting stand 104. Rather the operator may position the individual portions around the event to obtain the angular view or position the operator desires, such as a near 360 degree film viewpoint. Further, if the audio/video source(s) 108 transmit wirelessly with the switcher 110, the operator does not have to attach the RCA or S video cables from the audio/video source(s) 108 to the recorder 112. Similarly if the switcher 110 transmits wirelessly with the audio/video recorder 112, the operator does not have to attach the RCA or S video cables. In an embodiment, the RCA cables from each device are connected to the wireless components for transmitting when using an RCA or S Video based system.

Once the operator has positioned all the audio/video source(s) 108 to transmit the desired audio and/or video view or position and connected all the components, the operator is ready to operate the system. The operator should ensure there is a blank recordable media in the audio/video recorder 112. Optionally, the operator may insert a memory card into the audio/video recorder 112 to enable the audio/video recorder 112 to create a main menu on the recorded media.

The operator begins the recording by selecting the desired audio/video source 108 to record from by pressing the control button 202 on the switcher 110 corresponding to that desired audio/video source 108 (i.e. at the selected/desired angle of view). The operator then initiates the recording of the recorded media by activating the audio/video recorder 112 to record. Throughout the event the operator may transition from one viewpoint to another by switching from one audio/video source 108 to another. To switch from one audio/video source 108 to another the operator simply presses the control button 202 on the switcher 110 corresponding to the desired audio/video source 108. Thus, the operator is capable of producing a recorded media in real time with views from multiple different audio/video sources 108 within minutes after the event. Additionally, the operator may duplicate the recorded media in a duplicator allowing the operator to make a plurality of recorded media (1-100) either during or within minutes after the event to sell or distribute copies of the recorded event or access to the recorded media online, either during or within minutes after the termination of the event.

Alternatively, or additionally, the cameras and the device capturing equipment may be configured to be placed on a single platform. The platform may be placed around the operator's neck or torso utilizing straps to secure it. In such an embodiment, the operator may position himself or herself at any vantage point throughout the event to maximize filming position and access to the event. In another embodiment, the platform is designed to rest in the operator/user's lap when the operator is seated at the event or on any other surface. Alternatively or additionally, the operator may position the cameras in various locations around the event or may mount them on permanent fixtures throughout the location of the event.

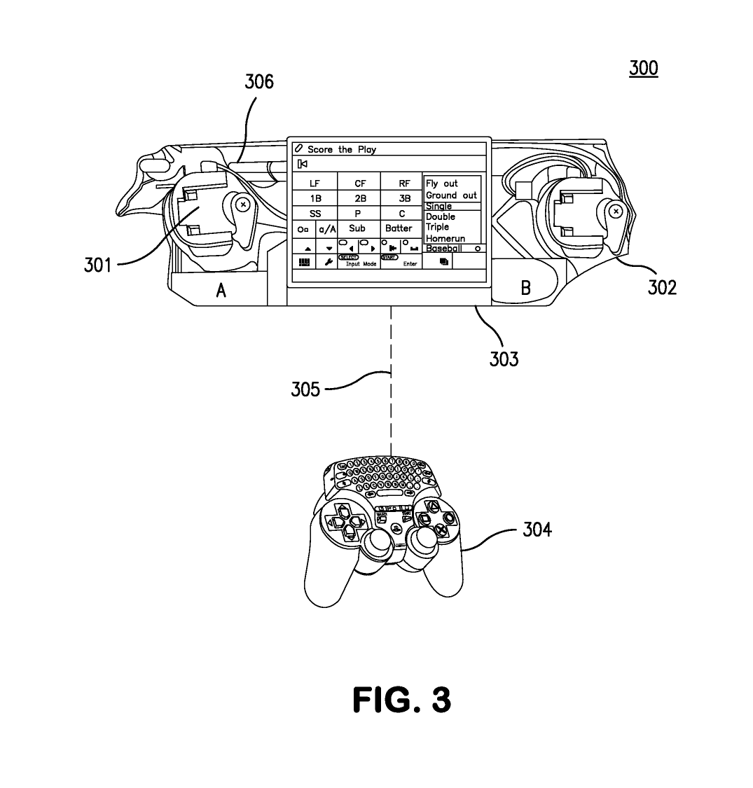

FIG. 3 illustrates a platform system 300 of the present disclosure. System 300 contains camera mounts 301 and 302, display 303, controller 304, and communications link 305 all mounted on platform 306. Platform 306 may rest in the operators lap or may hang on optional straps (not shown) to be worn around the operator/user's neck or torso. Additionally, or alternatively, platform 306 containing the recording and editing equipment may have a standard screw opening on the bottom, similar to those utilized by universal tripod attachments, thereby utilizing the base of the platform 306 as if it were the base of a camera for ease of deployment on a standard camera tripod. Such typical mounting devices may contain a ¼″ standard screw opening for ease of mounting.

Camera mounts 301 and 302 may also contain standard ¼″ screw mounts to hold various types of cameras, i.e., still, zoom, slow motion, video, etc. Mounts 301 and 302 may also hold their respective cameras utilizing other types of mounts, such as pressure mounts, compression mounts, locking cams, or any other type of mount that will rigidly hold the cameras in place. Camera mounts 301 and 302 may be mounted directly onto platform 306 or may extend above the top surface of platform 306. If platform 306 is used, the cameras may be mounted to the platform via telescoping mounts or may be remotely located from the platform and communicate their information wirelessly. Camera mounts 301 and 302 may me manually adjustable or may be motorized to allow for remote pan and tilt control. Display 303 is a multifunction display which allows the operator to view and/or select information about each team/player or each play or event, as well as view the information being captured by the cameras. Display 303 may be a touch screen or a display that is controlled by controller 304. Display 303 may be black and white or color and may be viewable in bright sunlight or dark. Controller 304 may contain an alphanumeric keyboard and various controller buttons and joysticks. Controller 304 is connected to system 300 via communications link 305 which may be a wired or wireless connection. Controller 304 allows the operator to control various camera functions, such as pan, tilt, focus, speed, power, etc. Controller 304 may also be used to enter and select data, play/player information, and control the overall operation of system 300.

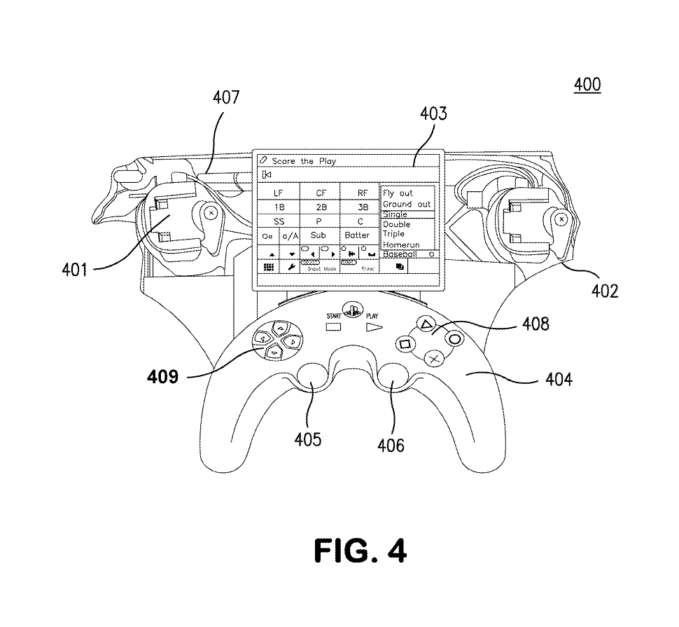

FIG. 4 depicts another embodiment of the present system wherein the controller 404 is incorporated directly into the platform 407. System 400 contains camera mounts 401 and 402, display 403, controller 404 and platform 407. Controller 404 contains joysticks 405 and 406 and controller selection buttons 408 and 409. Platform 407 may rest in the operator's lap or may hang on optional straps (not shown) to be worn around the operator/user's neck or torso. Platform 407 may also be mounted on a tripod, table top, or other surface for ease of use and positioning. Camera mounts 401 and 402 may contain standard ¼″ screw mounts to hold various types of cameras, i.e., still, zoom, slow motion, video, etc. Mounts 401 and 402 may also hold their respective cameras utilizing other types of mounts, such as pressure mounts, compression mounts, locking cams, or any other type of mount that will rigidly hold the cameras in place. Camera mounts 401 and 402 may be mounted directly onto platform 407 or may extend above the top surface plane of platform 407. Camera mounts 401 and 402 may be manually adjustable or may be motorized to allow for remote pan and tilt. Display 403 is a multifunction display which allows the operator to view and/or select information about each team/player or each play or event as well as view the information being captured by the cameras. Display 403 may be a touch screen display or may be an informational display that is controlled by controller 404. Display 403 may be black and white or color and may be viewable in bright sunlight or may be backlit for low light viewing. Controller 404 may contain an alphanumeric keyboard and various controller buttons and joysticks. Controller 404 is integrated into system 400. Controller 404 may control various camera functions such as pan, tilt, focus, speed, power, etc., utilizing joysticks 405 and 406 and/or controller selection buttons 408 and 409. Controller 404 is also used to enter and select data and options displayed on display 403.

Additionally, or alternatively, controller 404 may be removable from platform 407. In a removed configuration, controller 404 may control the cameras, recording and tagging through a wired or wireless connection. When removed from the platform 407, the controller 404 may communicate with the remaining components using a wired or wireless connection.

In another embodiment, the system is contained in a backpack worn by the user. The contents of the backpack may contain the recording and tagging equipment, while the camera(s) utilize the backpack as a mounting platform for a one or two camera system. The camera(s) may extend from the back pack and extend over the user's shoulder to capture the event. Such a configuration provides for ease of mobility and a walk and film technique. In such an embodiment, the user may rotate the camera with a simple twist of the wrist or the user can capture images and video with one camera always pointing forward and another camera with, for example, a high zoom lens to get “further into” the scene of the event. Another example would be one camera captures live action, while the second camera captures zoomed high speed slow motion. Further, the user may have a separate viewing screen and controller, thereby allowing the operator to view and tag the information being captured.

The cameras of the system may be wired or wireless and may be suitable for use in bright sunlight, in artificial light, or in low level light conditions. The cameras may have lenses in the range of 24 mm-330 mm lens, although other lenses of longer or shorter focal lengths may be utilized depending on the venue and the event. The cameras may have an effective frame recording speed of 24, 30, 60, 120, 240 frames per second for normal, high, and slow motion capture, although other higher and lower frame speeds are possible. Alternatively, or additionally, the cameras may have variable frame speeds which may be selected by the operator before the event or dynamically changed via the controller. Using such variable speed cameras allows for the simultaneous capture of slow motion video. As will be appreciated by those skilled in the art, other cameras and lens types may be utilized to capture the images and video with out departing from the invention.

Cameras should be of high quality and capable of both high speed slow motion and high zoom, preferably at least 25× optical zoom. Cameras should also be suited for exterior and prolonged use. In an embodiment, a Casio® Exilum FH 25 was used.

Power source for the system and cameras should be able to sustain all day operation without recharging. Replaceable batteries may be utilized to extend the capture capacity of the system. In one embodiment, an HBJ-12680 lithium ion polymer rechargeable battery provided approximately 6-9 hours of usage per camera. The battery had an input of 12.6v and an output of 12.6v-10.8v, as well as a 5v output. The battery has a capacity of 6800 mA and a recycle time of more than 1000 cycles. The battery used in the embodiment, was 9.3 cm×6 cm×2.8 cm and 11 cm×6.5 cm×2.5 cm when installed within a ruggedized plastic case and weighed 220 g without the case, and 320 g with the case. The system requires a storage device to hold and store the captured video media. Any writable digital storage media may be used to store the captured digital media, such as flash drive, hard disk, SD card, digital tape, optical disk, floppy disk, CD, DVD, thumb drive, cloud storage or transmission to an offsite location. In an embodiment, an 8 gigabyte SD chip was used. The 8 gigabyte card provided enough memory to store 20 minutes of high speed slow motion footage and 1.5 hours of 720 HD quality video using the Casio FH 25.

In an embodiment, the device comprised a complete data capture station, allowing one user to record videos and photos, and then seamlessly and quickly “tag” the media to be associated with the specific individuals involved at that moment, as well as relevant information, such as “scoring the play” for statistics or adding text notes to a scene or clip. In one embodiment, a dual camera system records simultaneously, but in different focal points and frame rates.

A wired or wireless controller used by the operator allows the operator to easily control the cameras and tagging with minimal dexterity and minimal loss of attention to the action of the event. In an embodiment, the controller may be similar to a video game controller and may contain a joystick, a thumbwheel, a trackball, or the like. For example, in such a configuration, a simple movement of the user's thumb may allow the user to control the pan and tilt motion of the cameras or adjust the focus and zoom of the cameras.

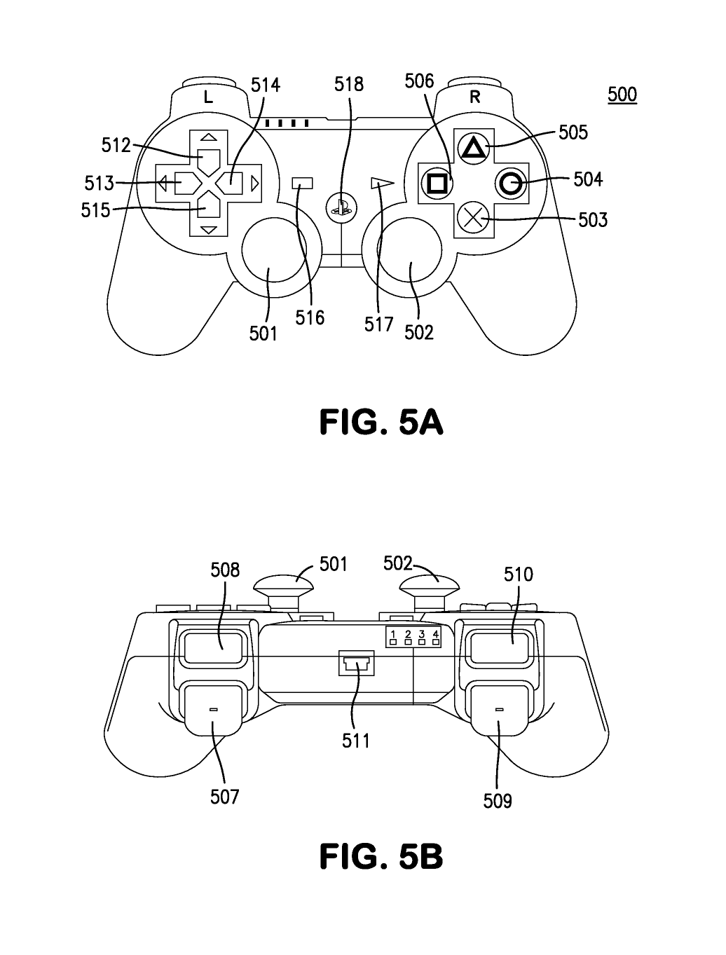

FIGS. 5(a) and (b) depict a typical controller for use with the present disclosure. FIG. 5(a) depicts a top view of controller such as controller 304 of system 300. While shown in a standalone configuration, it is to be understood that controller 500 may also be modified in form and function to integrate into built-in controller 404 of system 400. While the following function is described with respect to system 300, the controls and functionality apply as well to integrated controller 404 of system 400. Controller 500 has controls similar to those utilized in the video gaming industry. Controller 500 contains thumb controlled joysticks 501 and 502. Each may be used independently to control the pan, tilt, zoom, etc, of the cameras mounted in systems 300. Joysticks 501 and 502 may also be used to select the data entry from display 303 of system 300. Button 503 may be an enter button to select a highlighted entry from display 303. Button 504 may be used to control the record and stop functions of system 300. Buttons 508 and 510 may be used to switch or toggle the functionality of joysticks 501 and 502. Controller buttons 504, 505, 507, 509 and 512-517 may be programmed to perform various other system functions, such as power on/off, microphone on/off, remote lights, video display on/off, split screen display, play-replay display, maneuver the cameras to configured pre-set destination focal points, quick tag the content to associate to individuals while the content is still being recorded, i.e., thereby skipping the step of having to use the scroll menu (such as pressing button 503 in baseball would tag the first baseman), quick tag the play outcome (such as in basketball pressing button 508 records a scored basket, while pressing 510 records an assist), tag the real time and date of the action, add pre-set text or data (such as in entertainment production applying the next act and scene, and actors), add pre-loaded graphics, add or swap game audio with music pre-loaded company owned music especially useful for days when the wind produces a harsh listening experience, and toggle between manual and automatic filming. Port 511 may be a USB port or other communications port that allows controller 500 to communicate with system 300 or any other desired system. Controller 500 may also contain an alphanumeric keypad to allow a user to enter information, such as team roster, player names, numbers, etc. As will be appreciated by those skilled in the art, the controller may contain additional or fewer buttons and functions depending on the number and amount of cameras being controlled, the types of options available, and many other parameters of the system.

In an embodiment, the system has two cameras spaced approximately 10 inches apart to allow for wide coverage and zoom of the same event, although the system is not limited by any spatial limitations between cameras. For example, the cameras could be as close as 10 inches or, if remotely located, as far apart as opposite goal posts in a football stadium. Each camera may be individually focused, zoomed, aligned, panned, and tilted, manually or through the digital controller buttons. Additionally, both cameras may be controlled simultaneously by one manual or digital controller button.

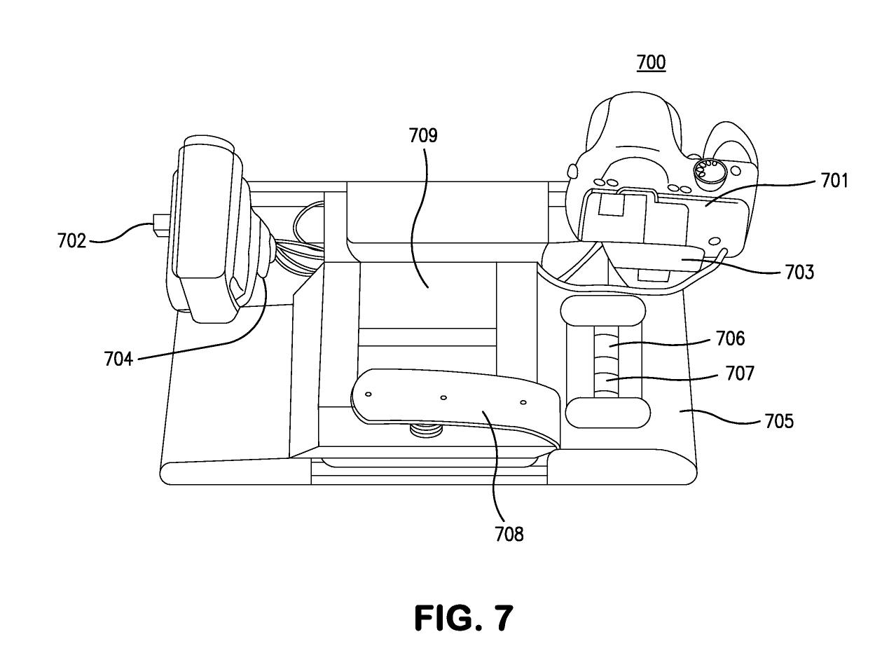

FIG. 7 depicts an embodiment of the device of the present disclosure. Device 700 contains Cameras 701 and 702 mounted to camera mounts 703 and 704, respectively. Platform 705 may be configured to be held by an operator on his or her lap, mounted to a fixture, such as a tripod, or may be shaped to be placed on a table or other structure. Switches 706 and 707 may control recording and zooming functions of cameras 701 and 702 or may be utilized for other operational functions, such as focus, pan, tilt, power on/off, switching, or any other function. Switch 708 may also be a universal switch with multiple functions, such as one touch record, or may be used to pause or stop the cameras 701 and 702 from recording. Multifunction display 709 allows the operator to view and select information about each team/player or each play or event, as well as view the information being captured by the cameras. Additionally, or alternatively, each camera has its own respective LCD type display to allow the operator to view the information being recorded by the cameras.

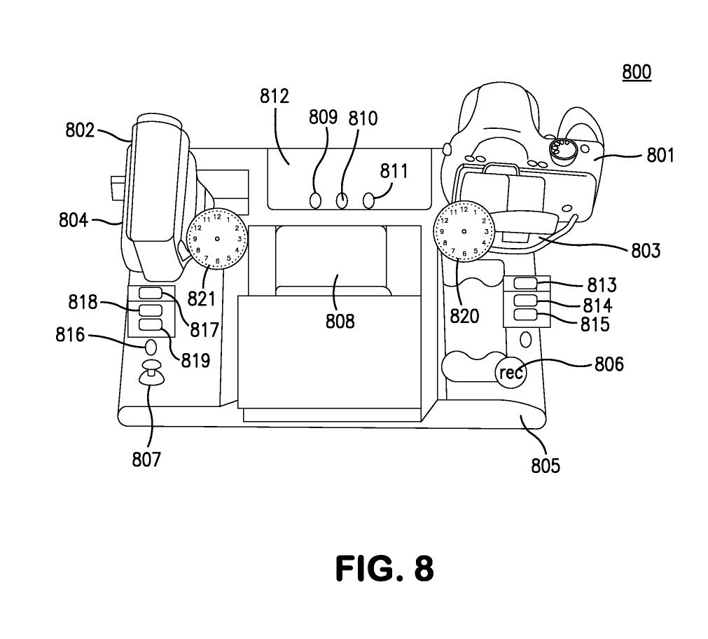

FIG. 8 depicts another embodiment of the device of the present disclosure. Device 800 contains cameras 801 and 802 mounted to camera mounts 803 and 804, respectively. Platform 805 may be configured to be held by an operator on his or her lap, or mounted to a tripod, or may be shaped to be placed on a table or other structure. Integrated into platform 805 is record button 806, which provides for one button record on/off. Device 800 also contains joystick 807, multifunction display 808, LEDs 809-811, battery compartment 812, switches 813-815, menu selection button 816, switches 818-819, and alignment dials 820 and 821. Alignment dials 820 and 821 contain markings that allow the operator to adjust the two cameras mounts, 803 and 804 to be easily positioned to point to the same location of the event. By turning the dials 820 and 821 to the same numbers, the mounts are positioned in the same relative position with respect to platform 805, thereby aligning cameras 801 and 802 to the same location. Utilizing the dials, 820 and 821, the operator may adjust the two cameras to be easily positioned to capture the same image. This also includes the option of using the dials as a programmable tool for precision recording, such that the user is able to easily configure the device onsite at the location and from the position they will film from, so that each button is a preset destination focal point for the cameras to move to (with each camera able to have the same or different focal point within that preset maneuver). For example, in baseball, the user has the option to press button 505 to instruct the cameras to the correct pan, tilt, and zoom level to focus on home plate for the batter, then when the ball is hit to second base, the user has the option to press buttons 505 to pan to second base preset, then press 504 for the throw to first base. In another example, in football, pressing the 505 button might instruct the system a pass play is occurring so that the left camera automatically focuses on the quarterback, while the right camera pans extra wide to capture the entire field of play starting from the edge of the left cameras focal point. Pressure sensitive buttons allow for variation in speed of the maneuver, as well as partial execution of the maneuver if action adjusts during the maneuver. Additionally, or alternatively, the user can preset parameters that emit a light, pressure touch, or sound as when the user passes notches on the dial, or enters a focal point that has been configured to be recognized to automatically tag those players when the camera is filming the location, which correlates to positions/players on the field, as defined by the user during configuration. Additionally, upon pressing a button defined as a preset focal point destination, the system automatically tags that content to associate to the individual playing that position, thus allowing the user to easily record with precision by pressing a button, while simultaneously auto tagging content.

Alternatively, or additionally, camera mounts 803 and 804 may be mechanically or electronically linked to ensure that they are easily simultaneously positionable to cause cameras 801 and 802 to be panned, focused, and tilted to the same location, or at locations that are far apart, up to a full 360 degree range. This may be accomplished using mechanical linkages or electronic sensors and motors. Joystick controller 807 may be integrated into platform 805 and allows the user/operator to simultaneously control one or both cameras pan, tilt, zoom, and focus movements. Multifunction display 808 allows the operator to view and select information about each team/player or each play or event, as well as view the information being captured by the cameras. Display 808 may be a touch screen or may be any other LCD type display. LEDs 809-811 may provide indicators to the operator such as in a guiding light system of operation, i.e., red=record, yellow=tag the recorded clip by adding text/statistics, and green=cycle complete, clip saved. Alternatively, or additionally, LEDs 809-811 may be combined into a single multicolor LED or may be used to indicate other functions, such as low battery, or low memory levels. Battery compartment 812 may be used to house batteries sufficient to provide power for device 800 through the length of a typical event. In an embodiment, one or more lithium ion poly 12 volt batteries at 6800 mA provided for approximately 9 hours of operations. Switches 813-815 may be used to control the left and right pan of camera 801, the up and down tilt of camera 801, and the zoom controls of camera 801. Similarly, switches 817-819 may be utilized to control the motions of camera 802. It is to be understood by one skilled in the art, that the switches and buttons described with respect to platforms 700 and 800 may be utilized for many functions and in many combinations without departing from the present disclosure. More or fewer switches and buttons may be utilized as well.

In an embodiment, the system employs a unique method of operation that takes the user through a simple step-by-step process to record media with tagged text data (statistics or notes). Text data inputting in an embodiment allows the user to select text data from digital menus similar to scrolling through a contact list of a mobile phone. The system then translates the text data selected and inputs that information into a database or spreadsheet for statistical comparison with other events and/or players. The selected text may contain such entries as “play outcome” i.e., score, penalty, etc. The selected text is then converted by the system into “book code” for the respective sport, which may then be input into the statistics spreadsheet or database. For example, the selection of a “K” at a baseball event may be translated into an entry for a strikeout in the database. In this manner, the system may utilize a universal text selection menu for all events, rather than a sport specific menu. Alternatively, and/or additionally, the system may have sport specific text selection submenus, to encompass unique features and events of the respective sport or event.

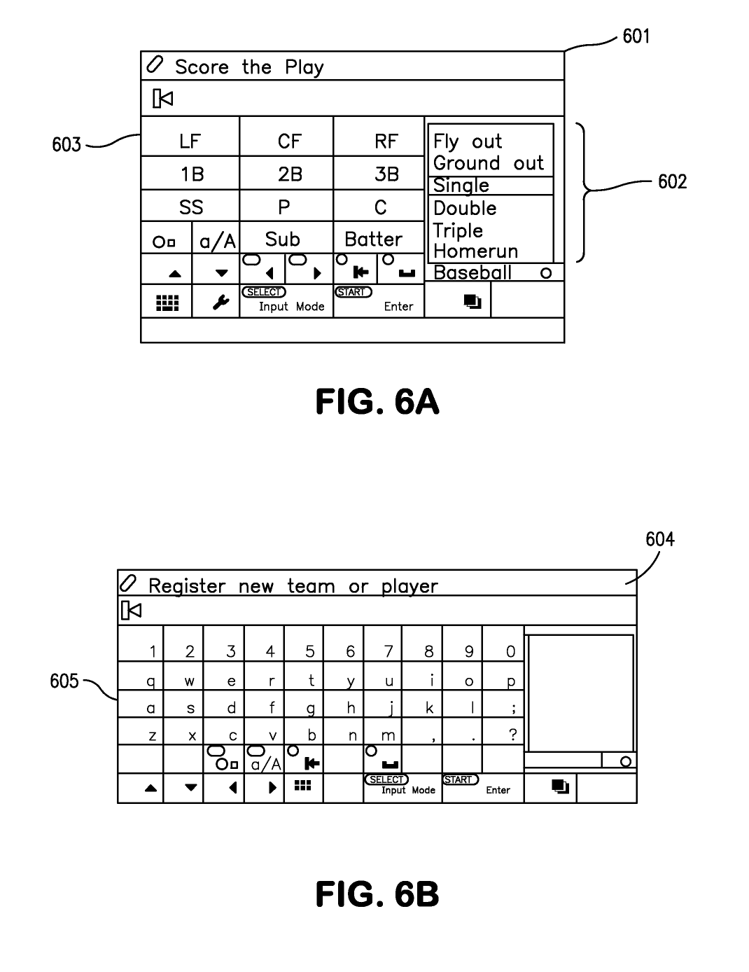

FIGS. 6(a) and (b) depict typical display screens found in systems 300 and 400. The display screens may be used to display the video images being captured by the cameras or may display text or data information selectable by the operator. The function of the display may be selected by the operator utilizing the controller. In video viewing mode, the operator may select standard video, slow motion video, split screen, etc. Additionally, the operator may use the screen for data entry. For example, the operator or user, during the recording of an event, can select to score a play by utilizing the “score the play” screen 601 utilizing the controller. After capturing the event (i.e., play on the field), the operator can utilize the joysticks to select the player, by position or name, or number, as listed in section 603 of the display. The operator may then input the outcome of the event, such as those listed in display section 602, i.e., single, double, etc. Selection may be accomplished by utilizing one of the many buttons on the controller or platform or by tapping on the screen. This selection is then associated with the captured event and stored in a separate spreadsheet file, linked to the captured video file.

In a similar manner, the operator utilizing the “register new team or player” menu 604 can input information about the team/players before the event, so that the player is available to the operator during the event. By manipulating the joysticks on the controller, the operator may select the appropriate alphanumeric information from the display to populate the information in the system. It is to be understood, that if the controller contains a separate alphanumeric keypad, selection may be made directly from the keys rather than from the display.

In an embodiment, the system contains lights to alert and assist the operator/user in tagging and recording individual plays or events. It is to be understood that other alerts, such as audio tones, vibrations, or any combination of alerts may be used. The alerts “walk” the operator/user through the recording and tagging process of each play or event of a recorded clip. As will be understood, by those skilled in the art, an event, especially a sporting event, may be broken down into a series of plays wherein each play is treated as a separate cycle.

In an embodiment, for each cycle or play, two media files (one from each camera or recording device) may be created and need to be tagged with relevant information. In an embodiment, visual alerts, such as lights, are used to alert the operator as to the next step in the process. A red light on the system may illuminate and turn on when the user presses the record button to start recording the play. A second, or the same light, may then illuminate again or in yellow when the user presses the record button a second time to stop recording the play. The second or yellow light is intended to remind the user to “score the play”, i.e., append text or statistics data to the recorded media. In an embodiment, scoring may be completed in two ways. An alpha/numeric keypad, located with the system may be utilized to quickly enter player uniform numbers, player position information, or other identifying information, or a digital scroll list may be used to select the play outcome in plain text data for the system to translate. Once a play is tagged, i.e., after the operator/user presses “score the play”, an indicator may illuminate green, signifying that the system is ready to record the next cycle or play. In an embodiment, lights located in the controller are used to alert the operator. For example, lights surrounding buttons 503 or 504 may be used to alert the operator as to the specific phase. Similarly, a separate light 518 may be used as an operator indicator. In another embodiment, lights mounted on the platform inform the operator/user.

In an embodiment, if the user is unable to “tag” the file with statistics or notes before the next play or cycle begins, the system will allow the user to go back and revisit a captured play at any time to view and “tag” the play with statistics or notes. In an embodiment, the system may add a title to the files which may contain a unique user identification number. The identification number may be associated with a team, a player, a position, or any combination of players, teams, or positions. The unique identifier allows the system to create defined paired files, i.e., the two simultaneously recorded video clips and the associated tagged text data file. In an embodiment, all data is processed into a separate spreadsheet or database for statistics and journal notes. It is to be understood, that the text (statistics or notes) associated with a respective video clip or individual are not permanently embedded into the media clip; rather, a separate file is created which can be added to a spreadsheet or database associated with the media it is paired with. The system creates separate text files that are “tagged” and/or associated with the video clips they correlate to. Accordingly, rather than embedding the text into the clip itself, the system creates a separate text file that can be linked and added as a file into the spreadsheet or database. In this manner, the video clip is not altered and the system application allows the system to deliver the previously inputted text in defined template locations on a screen when viewing playback.

In this manner, the system allows for the display of the text data in a variety of templates when the media clips are replayed, including for example, lower ⅕th panel, pre-roll, or post-roll or any other text/video overlay. As understood, by those skilled in the art, a lower ⅕th overlay will display the selected text on the lower ⅕ of the screen, Such a display is advantageous when showing clips that are joined together in a continuous format. A pre-roll, may be a 3 second text card that provides for an introduction for a single clip. Like a pre-roll, a post-roll or end credit, is a 3 second or more text card appended to the end of the media clip. In other embodiments, the text files may be imported and/or exported into a text editor to enhance the information and impact of the appended text with respect to the media clip. Additionally, and/or alternatively, computer based tools may also be used to add, edit, and format text and graphic images to associate with media images. Further, in an embodiment, text and images may be imported into standard industry editing programs such as Adobe Photoshop® or Apple® Final Cut. In an embodiment, other types of media files, such as music files may also be associated with the tagged video file.

Preproduction setup before an event reduces the amount of data input an operator must perform while recording and tagging the data. In an embodiment, pre-production setup may include, updating team/player information such as position, ID number, uniform number, name, team name, etc. in a database or spreadsheet. This may be performed utilizing the display screen shown in FIG. 6(b) directly on the device, or the system may also be plugged into a general or special purpose computer, laptop, tablet, or any other computing type device, containing, memory, RAM, I/O device, display, processor, communications device, and interface device, to update teams, players, schedules, and rosters. Additionally, and/or alternatively, the information may be provided wirelessly to the device, computer, laptop, or tablet upon request from the operator or as pushed information to an operator. The update process allows coaches and team leaders to “add their team” to the system, wherein each player on a team roster registers or links his information to his or her team. By linking to a team, a player links his or her contact information, such as e-mail address to a uniform number, team, position, or name that will enable the user to identify the player during the event. Such information may be used by the operator to monetize the media files to interested parties and event participants.

In operation and once at the event, or on the day of the event, the operator/user identifies and selects the teams involved in the event, i.e., team “a” vs. team “b”. The information associated with the respective teams is then available to the operator/user during the recording of the event and allows the operator/user to tag the respective media/video clip with the proper player information. During the game the operator/user is prompted either visually, audibly, or otherwise to “score the play” immediately upon completion of each play and each recording cycle, i.e., a single “start-stop” interval. Because all the player and team information has been added previously, the operator/user is able to minimize the time required to tag the media clip, thereby minimizing the possibility of failing to capture the next cycle or play. Some buttons can be dedicated to quick tag individuals even while the play is still being recorded. Buttons can also be configured to move the cameras into preset focal point destinations automatically while simultaneously tagging that play to the individual(s) at those positions, reducing tagging times. Preset buttons on the controller can also be dedicated to the top play outcomes per sport, to further reduce tagging time.

While the above embodiments have disclosed cameras mounted and located in various locations, it will be appreciated by those skilled in the art, that the cameras may be mobile and or movable with respect to the field of action. For example, a camera capture pod that is protected and impact resistant may be located on, adjacent to, or very near the playing filed for on field recording. Such on the field placement, allows the cameras and, accordingly, the viewers, to get inside the action during a practice or a game. Such a device may be padded for protection during player collisions, has a small footprint, and is mobile. The mobile capture pod may include a single or double camera system mounted in a protective enclosure to protect it from contact and impact with players, balls, and obstacles.

As will be appreciated by those skilled in the art, the capture pod may be placed in a fixed position or may be movable and/or mobile. Control of the pod, as well as transmission of the data, may be wired or wireless. The pod, which may be associated with a robotic car or robotic dolly system is capable of self righting and can withstand being hit by a projectile, such as a baseball, football, soccer ball, puck, or any other type of ball or equipment. Further, the capture pod must be ruggedized to such a degree as to absorb a player's impact in case of collision. As will be appreciated by those skilled in the art, the use of such a capture pod allows the operator to get close to the action while allowing the operator/user to maintain a safe distance from the players and possible projectile impacts. Additionally, the protective case of the pod may contain any type of foam padding and/or other protection to protect both players that may accidentally impact the pod and the pod equipment itself.

In another embodiment, a wireless camera is mounted to a remote controlled vehicle or dolly that runs on pre-built track. The track restricts the cameras movement, but allows for easy forward and back control that mimics existing cable systems. The operator/user has similar capability of a professional cable system, but without the danger of being directly over the field of play, and the ability to fix the track to the facility for unique visual effects. While many other applications are possible, such a wireless track system is ideal for use in gymnasiums and running tracks.

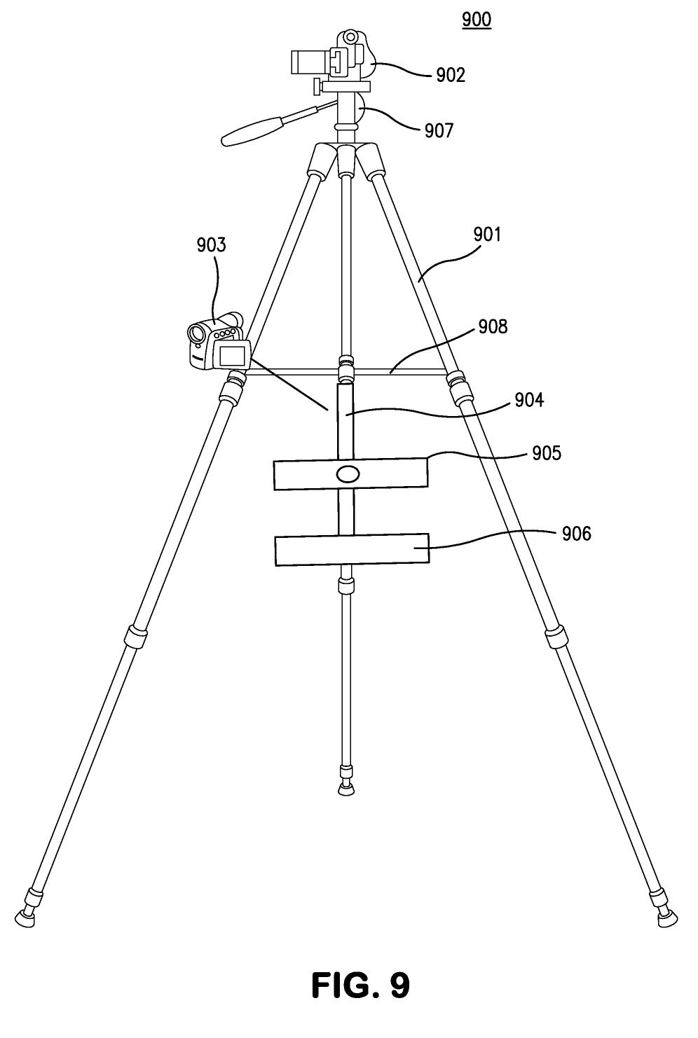

In an embodiment, a standard tripod may be utilized instead of a platform to mount one or more cameras. FIG. 9 depicts an embodiment utilizing a standard tripod mounting system. System 900 contains tripod 901, cameras 902 and 903, mount 904, recorder or burnbox 905 processor 906 and camera mount 907. Burnbox 905 contains a video recorder, such as a DVD burner or any other device that records video to a recordable medium such as a flash drive, hard drive, thumb drive, or other memory device, and a power source such as a battery power source that provides sufficient power to the system 900 for between 9-12 hours of operation. Additionally, or alternatively, burnbox 905 may also contain a video switcher to select the video from either cameras 902 and 903. Tripod 901 may be a standard tripod containing a camera mount 907, typically used by photographers to mount video equipment. Camera 902 connects to mount 907 and may be a standard video camera and/or may optionally contain its own recording device or recording medium. Camera 902 may be a standard camera or a camera capable of high zoom, slow motion, etc. Camera 903 may be the same type or different type than camera 902 and mounts to a different location on tripod 901. Camera 903 utilizes an alternative mount, that allows it to attach to a leg of tripod 901 by any one of known means. Additionally, or alternatively, camera 903 may be remotely mounted from system 900 and communicate its information to system 900 via a wired or wireless connection. Mount 904 may be a universal metal stem that attaches to a standard ¼″ tripod screw located on the underside of camera mount 907 or on the leg support brackets 908. Burnbox 905 attaches to mount 904 and hangs below tripod 901, thereby utilizing previously unused space. Alternatively, or additionally, processor 906 may be attached to burnbox 905. Processor 906 may be a laptop computer, a tablet computer, a smart phone, or any other device capable of processing, storing, transmitting, and receiving data. Processor 906 may communicate with burnbox 905 wired or wirelessly, and the recorder within burnbox 905 may likewise communicate with cameras 902 and 903 via wired or wireless connections. In operation, burnbox 905 records the data being captured by cameras 902 and 903 and allows the operator/user to tag the data as it is being captured. At the end of the entire event or at the end of a cycle, i.e., a period, inning, half time, an individual play, an individual at bat, or at any other time, the operator can upload the captured images and tagging information to a database for redistribution and sales to end users. As will be understood, by those skilled in the art, system 900 may utilize a single camera or multiple cameras.

The device of the present system empowers a single user to produce network quality video of sports and other events, such as concerts, and to annotate, tag, and easily distribute such clips. While the invention has been described and illustrated in connection with illustrative embodiments, many variations and modifications will be evident to those skilled in the art and may be made without departing from the spirit and scope of the invention. The invention is thus not to be limited to the precise details of methodology or construction set forth above as such variations and modification are intended to be included within the scope of the invention.

1. A mobile multi-angle audio and video production system comprising:
a carrying case having an interior and an exterior;
at least one storage compartment contained within said interior of said carrying case;
at least one mounting stand attached to said exterior of said carrying case;
at least one mounting platform rotatably attached to said at least one mounting stand;
at least one audio/video source having at least one audio/video output port, said at least one audio/video source mounted on said at least one mounting platform;
a switcher having at least one audio/video input port to receive an audio/video output transmission from said at least one audio/video source, said switcher being capable of accepting said audio/video transmission from a plurality of said audio/video sources;
at least one control button on said switcher, said at least one control button corresponding to a specific one of said audio/video sources; and
an audio/video recorder having at least one audio/video input port to receive audio/video output transmission from said switcher and produce a removable recorded media.

2. A mobile video production system comprising:
at least one camera for capturing a digital media data;
a recording device for storing the digital media data;
a tagging device for tagging the digital media data with a related information data; and
a processor for associating the digital media data with the related information data.

3. The system of claim 2, further comprising a second camera for capturing a second digital media data, wherein the second digital media data has a different attribute then the digital media data.

4. The system of claim 3, wherein the tagging device tags the second digital media data with a second related information data and wherein the processor associates the second digital media data with the second related information data.

5. The system of claim 4, wherein the related information data identifies at least one portion of the second digital media data.

6. The system of claim 4, wherein the second related information data identifies at least one location in the digital media data.

7. The system of claim 3, wherein the attribute is chosen from at least one of the following:
a focal length, a focal position, and an image speed.

8. The system of claim 3, further comprising a platform, wherein the at least one camera, the second camera, and the tagging device are all mounted to the platform, and
wherein the at least one platform further contains an alignment device for aligning the positioning of the at least one camera and the second camera.

9. The system of claim 8, where the alignment device is manual.

10. The system of claim 8 wherein the platform further comprises:
a controller for simultaneously controlling the alignment of the at least one camera and the second camera.

11. The system of claim 2 further comprising a controller.

12. The system of claim 11, wherein the controller is used to control the at least one camera and the tagging device.

13. The system of claim 2 further comprising a multifunction display.

14. The system of claim 13, wherein the multifunction display can display at least one of the following:
a slow motion video stream, a still photo, a video image, a split screen image, a menu, and a data screen.

15. The system of claim 2, further comprising a platform, wherein the at least one camera, the tagging device, and the processor are all mounted to the platform.

16. The system of claim 2, wherein the at least one camera transmits the digital media data wirelessly to the recording device.

17. The system of claim 15, further comprising a controller integrated into the platform.

18. A method for capturing and tagging event video comprising:
capturing a first video stream via a first camera;
capturing a second video stream via a second camera, wherein the first video stream and the second video stream are captured simultaneously;
recording the first video stream in a digital format and the second video stream in the digital format;
tagging the associated first video stream and the second video stream with a data file;
associating the first video stream with the second video stream and the data file; and
storing the first video stream, the second video stream, and the data file, wherein the first video stream, the second video stream and the data file are stored as separate files.

19. The method of claim 18, wherein the data file is selected from a list of predefined identifiers.

20. The method of claim 18, further comprising an audio or visual alert for instructing a user on completing the recording and tagging portions of an event.

21. The method of claim 18, wherein the tagging associates either the first video stream, the second video stream or the data file with one or more individuals involved in the first or second video stream.

22. The method of claim 18, wherein the tagging associates at least one portion of the second video stream to a location in the first video stream.

23. The method of claim 18, wherein each of the first video stream and second video stream are at least one of video, one or more still images, slow motion video, one or more zoomed images, and high speed video.
